(19) United States
(12) Patent Application Publication
(10) Pub. No.: US 2009/0067445 A1
(43) Pub. Date: Mar. 12, 2009

(54) ROUTER AND ROUTING NETWORK

(75) Inventors: Jean-Philippe Diguet, Guidel (FR); Samuel Evain, Saclay (FR)

Correspondence Address: Howard IP Law Group, P.O. Box 226, Fort Washington, PA, 19034, US

(73) Assignees: CENTRE NATIONAL DE LA RECHERCHE SCIENTIFIQUE, Paris Cedex 16 (FR); UNIVERSITE DE BRETAGNE SUD, Lorient Cedex (FR)

(21) Appl. No.: 12/091,830

(22) PCT Filed: Oct. 27, 2006
(86) PCT No.: PCT/FR2006/051121

§ 371 Date: Sep. 11, 2008

(30) Foreign Application Priority Data
Oct. 28, 2005 (FR) 0553280

(51) Int. Cl. H04L 12/56

(52) U.S. Cl. 370/419

(57) ABSTRACT

A router in which each of the input/output ports is associated with identifiers enabling each of the other input/output ports to locate it according to a code specific to each of them, comprising means for identifying in an incident packet a routing instruction indicating a forward identifier of the desired output port; and means for sending back the packet where the forward identifier is suppressed from the routing instruction and a return identifier is inserted therein.

### FIELD OF THE INVENTION

The present invention relates to the routing of data packets between various digital devices.

### DISCUSSION OF THE RELATED ART

In certain cases, it is preferred to use networks of routers, each of which is capable of transmitting messages between one of its inputs and one of its outputs during a given time slot rather than using a bus.

Routers and routing networks are more specifically adapted to be integrated on an integrated circuit chip comprising several devices such as processors and memories, to enable very rapidly routing data packets between the various devices.

A router is a device comprising a number of input and output ports. It will here be considered that each port is an input/output port, given that the input and output ports may be distinct, but that each input port will correspond to an output port and conversely. Conventionally, a router comprises at least one instruction decoder per input port, an arbitration logic circuit, a switching system between each input and each output, and memory, currently a FIFO memory for temporarily storing the data packets, for example, during a clock pulse, between their input and their output. Each input/output port of a router is associated with an input/output port of another router or of a device. According to structures, the number of ports of each router of a routing network is constant or variable.

Currently, in a router network formed on an integrated circuit, the number of routers is decreased. Currently only a few tens of routers are used in an integrated routing circuit.

It should be noted that some of the devices connected to the router network may themselves be used as routers when they have several input/output ports, which is for example the case for many processors.

Further, each data packet comprises a header especially containing routing instructions and data. Currently, in on-chip integrated systems, the size of the header, which especially corresponds to the path to be followed, is not negligible with respect to the amount of conveyed data.

Thus, a first constraint of a routing network and of the associated routing method is to minimize the size of the routing instructions enabling conveying a data packet from one device to another.

Another imperative of a routing network integrated on a chip is to minimize the dimension of each of the routers and to optimize their various performances, especially in terms of consumption and complexity.

It is also desired to provide routing methods in which a data packet having reached its destination will contain the elements necessary for its return to the source from which it originates.

An object of the present invention is to provide a router and a routing network enabling satisfying at least some of the constraints discussed hereabove.

### SUMMARY OF THE INVENTION

The present invention is based on a specific identification mode of the input/output ports of a router: rather than identifying these ports in absolute fashion, they are located relatively to one another.

More specifically, the present invention provides a router in which each of the input/output ports is associated with identifiers enabling each of the other input/output ports to locate it according to a code specific to each of them, comprising means for identifying in an incident packet a routing instruction indicating a forward identifier of the desired output terminal; and means for sending back the packet, where said forward identifier is suppressed from the routing instruction and a return identifier is inserted therein.

According to an embodiment of the present invention, the input/output ports are cyclically sequenced in a determined order, the forward identifier corresponds to the cyclic shift between the input port and the output port, and the return identifier corresponds to the difference between the router's arity and said shift.

The present invention also provides a routing network comprising routers of the above type, in which a packet sent from a source to a destination comprises a routing instruction containing the successive identifiers of the output port with respect to the input port for each of the routers through which the packet must transit.

According to an embodiment of the present invention, the identifiers are arranged sequentially in the order of the routers through which the packet must transit, whereby the head instruction of a packet leaving a router is the identifier of the next router.

According to an embodiment of the present invention, in each router, the return identifier is inserted at the end of the routing instruction.

According to an embodiment of the present invention, each destination comprises means for resequencing the received routing instruction, corresponding to a sequence of return identifiers, to form a destination-to-source routing instruction.

According to an embodiment of the present invention, said difference is inserted after having inverted the order of its bits and, to obtain a return path, the routing instruction is read in reverse order.

The present invention also provides an integrated circuit containing a routing network of the above type.

The present invention also provides a routing method in a routing network in which each router comprises means for identifying, in a routing instruction of an incident packet, a forward identifier indicating the relative position of a desired output port, and means for sending back the packet by suppressing from the routing instruction said forward identifier and by inserting a return identifier therein, this method comprising, to send a message from a source to a destination, the step of sending from the source the sequence of identifiers of the output ports to be selected by routers provided in advance to convey a data packet from the source to the destination.

### BRIEF DESCRIPTION OF THE DRAWINGS

The foregoing and other objects, features, and advantages of the present invention will be discussed in detail in the following non-limiting description of specific embodiments in connection with the accompanying drawings, in which:

FIG. 1 schematically shows a routing network between various devices of a system;

FIG. 2 illustrates a convention for locating ports of a router according to the present invention;

FIG. 3 shows the outlook of a conventional data packet;

FIG. 4 illustrates an example of the routing of a data packet by a routing network and the variation of the data packet header before and after passing through each router and device on transfer from a source device to a destination device and returning towards the source device; and

FIG. 5 illustrates a mode for storing routing instructions in the header of a data packet according to a specific embodiment of the present invention.

### DETAILED DESCRIPTION

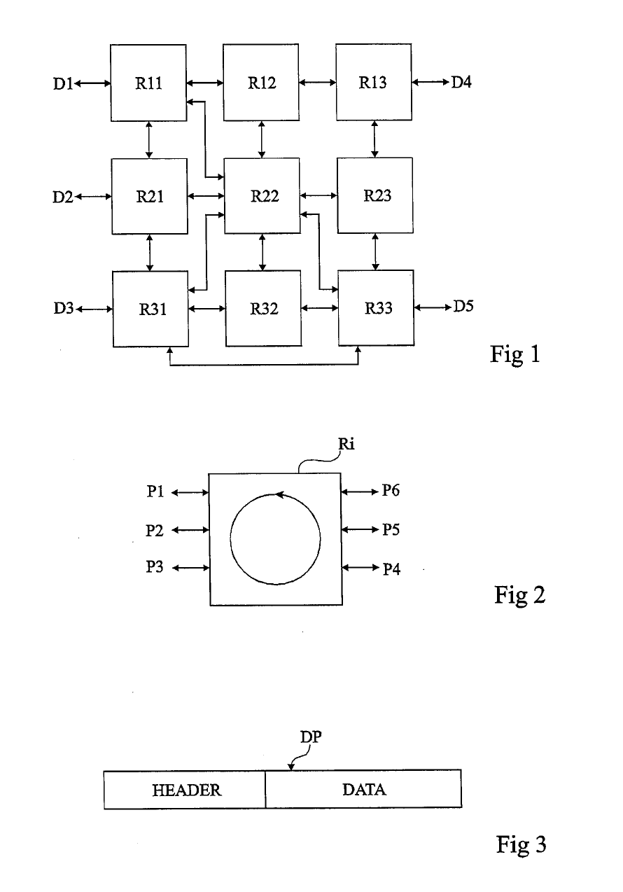

FIG. 1 schematically shows in simplified fashion an example of a routing network comprising nine routers R11-R13, R21-R23, R31-R33 intended to ensure the transmission of data packets between devices D1 to D5, each of which may be, for example, a processor, a memory, or a router. The links between the different routers and devices can be seen in the drawing. It should only be noted that:

routers R12, R13, R23, and R32 only comprise three ports (respectively connected to device D4, to router R12, and to router R23 as concerns router R13),

routers R11 and R21 comprise four ports,

routers R31 and R33 comprise five ports, and

router R22 comprises seven ports, respectively associated with each of the other network routers, excluding router R13.

The example of FIG. 1 is extremely simplified and is only intended to ease the explanation and the understanding of the present invention.

FIG. 2 shows a router Ri. For each router, an arity, that is, the number of input/output ports associated with this router, is defined. In the example of FIG. 2, the router comprises six input/output ports P1 to P6. In other words, this router has an arity of 6. According to the present invention, whatever the effective hardware arrangement of the input/output ports, these ports are a priori sequenced cyclically in a determined direction. In the drawing, the ports are sequenced in the trigonometric rotation order (counterclockwise) from port P1 to port P6. Thus, a number of steps or shift between any two ports can be defined. Port P5 is for example two steps away, or two cyclic shifts away, from port P3, and port P3 is four steps away from port P5. The shift between ports P6 and P1 is equal to 1, and the shift between ports P1 and P6 is equal to 5. In the two above examples, it should be noted that the sum of the shifts is equal to 6. Indeed, it should be clear that the sum of the shift between a first port and a second port and of the shift between this second port and the first port is equal to the arity.

As shown in FIG. 3, any data packet DP comprises a header and data. The header especially comprises routing instructions. According to the present invention, a routing instruction between a source and a destination comprises the successive shift values between the input port and the output port of each of the routers of the followed path.

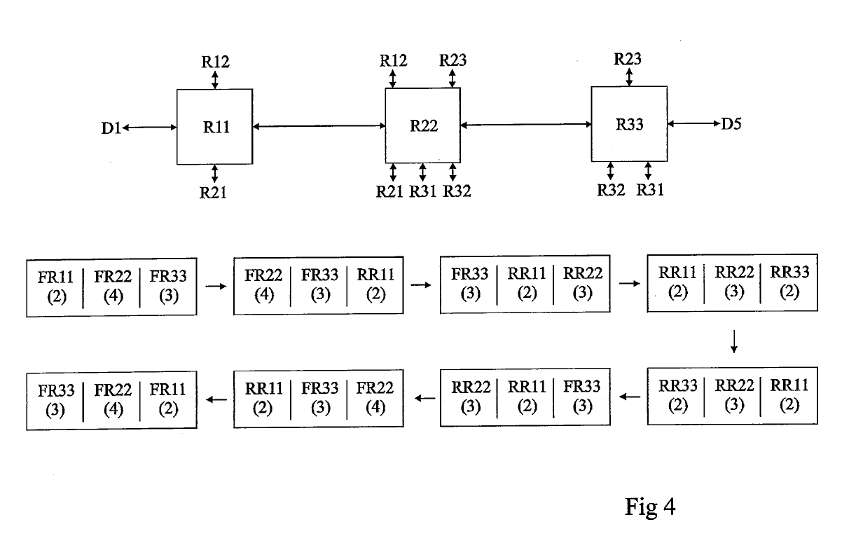

In the example illustrated in FIG. 4, it is assumed that a data packet is desired to be transmitted from device D1 to device D5 through routers R11, R22, and R33 (also see FIG. 1). At the top of FIG. 4, the sequence of routers and devices implied in the considered data packet transfer has been shown. For each of routers R11, R22, and R33, the ports other than the useful ports have been indicated. Thus, as illustrated in FIGS. 1 and 4, for a data packet to transit from device D1 to device D5, a router R11 must provide a shift of 2, router R22 must provide a shift of 4, and router R33 must provide a shift of 3. For this purpose, the routing instruction, belonging to the header sent by element D1 and shown under this device D1 in FIG. 4, comprises the shifts to be successively brought by routers R11, R22, and R33. These shifts are respectively designated as FR11, FR22, and FR33 (F being used to designate the forward propagation direction, that is, from D1 to D5). Thus, routing instruction FR11-FR22-FR33 received by router R11 is equal to 2-4-3.

In router R11, the first shift instruction (FR11=2) makes the incoming packet come out from the second port which is encountered counterclockwise, that is, the port linked to a link connected to a port of router R22. Router R11 sends back the incident packet by modifying the header as follows:

suppressing the first shift instruction (FR11), and

adding a return instruction RR11 which indicates the number of shifts between the output port (from router R11 to router R22) and the input port (connected to device D1). Return instruction RR11 is the complement (2) of instruction FR11 (2) with respect to the arity (4) of router R11. Preferably, as shown, the shift instructions are arranged in order FR22, FR33, RR11, before reaching router R22.

Router R22 detects the instruction which is intended for it (FR22=4) and deduces therefrom that the incident packet must come out from the fourth port counterclockwise after the input port, that is, the data packet must neglect the ports directed towards routers R21, R31, and R32 to come out from the port directed towards router R33. At the output of router R22, the routing instruction which initially was FR22-FR33-RR11 is replaced with routing instruction FR33-RR11-RR22, that is, forward shift instruction FR22 is suppressed at the head of the routing instruction and return shift instruction RR22 is added at the end of the routing instruction. This method especially enables avoiding use of a pointer on the instruction to be decoded and/or of a bit specifying the read direction according to whether the message is a forward or return message.

Router R33 receives shift instruction FR33=3. The data packet thus comes out towards device D5, instruction FR33 is suppressed, and instruction RR33, that is, value 2, which is the complement with respect to the arity (5) of the input instruction (3) is arranged at the end of the routing instruction.

Thus, at the input of device D5, shift instructions RR11-RR22-RR33 which enable return of a data packet towards the device from which it has been transmitted can be successively found. Such data can be used for various purposes, for example:

to identify at the level of the destination device (D5) the source (D1) of the received data packet;

to send back a data packet from the destination device (D5) to the source device (D1), without knowing the identity of the source. The data packet sent back may for example be an acknowledgement, a response, or the actual arrived data packet in case of an error detection at the levels of the routing instruction coding or of the conveyed data.

To perform a return, routing instruction RR11-RR22-RR33 is set back at the level of device D5 in order RR33-RR22-RR11 and the packet is sent back from device D5 to device D1 in a way similar to what has been discussed previously, each router suppressing data RR that it receives and replacing them with a corresponding instruction FR, that is, the complement with respect to the arity of the received shift instruction. One can thus find at the level of device D1 the packet with, in its header, routing instruction FR33-FR22-FR11, which may be returned and which may be used for various purposes, as indicated previously (verification, return, security . . . ).

The present invention is likely to have many variations which will occur to those skilled in the art. Especially, the header of data packet DP, see FIG. 3, may contain other data in addition to the routing data corresponding to the previously-indicated shift values. These other data may correspond to various service data. It may also be provided to additionally insert, conventionally, although this is not necessary, data ID relative to the identity of the source device or of the routers traversed, to further increase the security or the verification capacities.

The present invention enables providing particularly short header words since it is only necessary to provide in the routing instruction the shift instructions of the various routers which must be used, and since the routing instructions of the return path are not added to the routing instructions of the forward path. Instead, a return shift instruction is substituted in a routing instruction to each forward shift instruction. Thus, the header word keeps a constant length during the progress of the packet and on return of this packet.

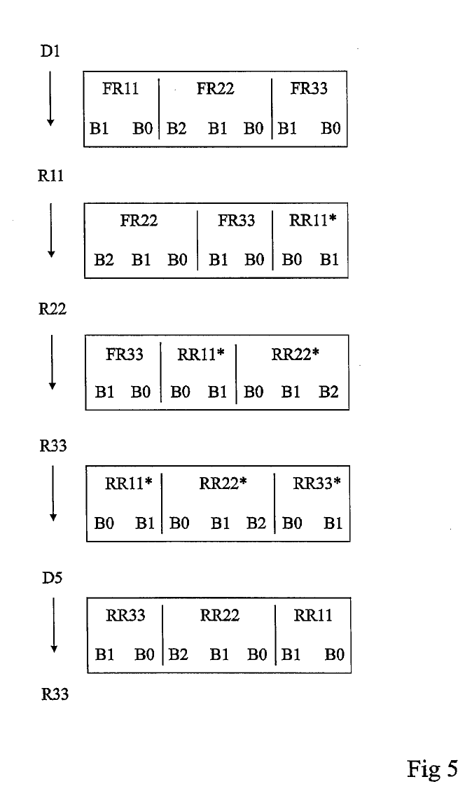

FIG. 5 illustrates a specific embodiment of the present invention intended to further decrease the size of the routing instruction. In this drawing, the evolution of the routing instruction on transfer of a packet from device D1 to device D5 has been shown, as in the previous example, through routers R11, R22, and R33. It is assumed that, as in the example illustrated in FIG. 1, the different routers have different arities. It should be noted that, for a router of arity 3, only two shifts are generally used, since a shift of 3 would designate a superposition of the input and output ports, that is, no action. These two “useful” shifts may be represented by a binary number with a single bit. Similarly, a router of arity 5 exhibits four useful shifts which may be represented by a two-bit binary number, and a router of arity 9 exhibits eight useful bits which may be represented by a three-bit binary number. Thus, the number of bits of the shift instructions associated with each router depends on the arity of the router and the used number of bits can be minimized by taking this fact into account. In the previously-shown example, router R11 has an arity of 4, router R22 has an arity of 7, and router R33 has an arity of 4. Thus, the shifts of these routers may be represented by binary numbers respectively with two bits, with three bits, and with two bits. Hereafter, in a binary number, the least significant bit will be called B0, the first more significant bit will be called B1, the next more significant bit will be called B2, and so on. Thus, a two-bit number will be called B1-B0 and a three bit number will be called B2-B1-B0.

Resuming the instructions to go from D1 to D5 illustrated in relation with FIG. 4, the routing instruction sent by device D1 to router R11 comprises shift instructions FR11, FR22, FR33, which will respectively be two-bit, three-bit, and two-bit binary numbers. In this embodiment, instead of placing shift instruction RR11 (the complement of FR11 with respect to the arity of router R11) at the output of router R11 at the end of the routing instruction, inverted instruction RR11* in which least significant bit B0 comes first is placed there. Similarly, at the output of router R22, there will successively be shifts FR33, RR11*, and RR12*, then at the output of router R33, shift instructions RR11*, RR12*, and RR13*. The fact of arranging the bits of the complement with respect to the arity of an input value in an inverted order by no means complicates the logic circuits for calculating this complement. However, in destination device D5, to obtain return shift sequence RR33-RR22-RR11, it will be enough to read instruction word RR11*-RR12*-RR13* from left to right instead of reading it from right to left. In other words, the routing instruction as a whole at the output of device D5 corresponds to the reversal of the instruction received by D5. This may be performed in particularly simple fashion by a wire crossing.

In the foregoing, the way in which each router identifies the shift instruction which is intended for it has not been indicated. This however is not a problem since each router knows its own arity and knows that the instruction which is intended for it is an instruction of a given number of bits. Thus, each router will simply regard the first relevant bits of the routing instruction: the first two for router R11, the first three for router R22, and the first two for router R33.

This specific embodiment of the present invention enables even better achieving the aimed objects by decreasing the dimension of the routing instruction in any transmitted data packet.

The present invention has been described in the context of a specific embodiment, currently preferred. Generally, the present invention aims at a particularly simple routing method in a routing network in which, for each router, the input/output ports are defined relatively with respect to one another, and not necessarily by the cyclic shift method described in detail hereabove. For example, each port may be located with respect to the other by a sequence number. Thus, each port will have with respect to another a forward identifier and a return identifier.

Among the possible choices of forward and return identifiers, it should be understood that encrypted combinations may be selected, enabling better resisting to fraud attempts. The present invention indeed enables identifying the transmitter since the return routing instructions reveal its identity. This type of identification may replace or complete current techniques of authentication by transmission of a certificate.

The present invention may be used by a forward by default routing where the instructions do not address all the routers traversed but merely some of these.

1. A router having input/output ports, each of the input/output ports is associated with identifiers enabling each of the other input/output ports to locate it according to a code specific to each of them, comprising:
means for identifying in an incident packet a routing instruction indicating a forward identifier of the desired output port; and
means for sending back the packet where said forward identifier is suppressed from the routing instruction and a return identifier is inserted therein.

2. The router of claim 1, wherein the input/output ports are cyclically sequenced in a determined order, the forward identifier corresponds to the cyclic shift between the input port and the output port, and the return identifier corresponds to the difference between the routers arity and said shift.

3. A routing network comprising a plurality of routers, each router having input/output ports, each of the input/output ports is associated with identifiers enabling each of the other input/output ports to locate it according to a code specific to each of them, each of said plurality of routers comprising:
means for identifying in an incident packet a routing instruction indicating a forward identifier of the desired output port; and
means for sending back the packet where said forward identifier is suppressed from the routing instruction and a return identifier is inserted therein,
wherein a packet sent from a source to a destination comprises a routing instruction containing the successive identifiers of the output port with respect to the input port for each of the routers through which the packet must transit.

4. The routing network of claim 3, wherein the identifiers are arranged sequentially in the order of the routers through which the packet must transit, whereby the head instruction of a packet leaving a router is the identifier of the next router.

5. The routing network of claim 4, wherein, in each router, the return identifier is inserted at the end of the routing instruction.

6. The routing network of claim 3, wherein each destination comprises means for resequencing the received routing instruction, corresponding to a sequence of return identifiers, to form a destination-to-source routing instruction.

7. The routing network of claim 6, wherein the input/output ports are cyclically sequenced in a determined order, the forward identifier corresponding to the cyclic shift between the input port and the output port, and the return identifier corresponding to the difference between the router's arity and said shift, and wherein said difference is inserted after having inverted the order of its bits and wherein, to obtain a return path, the routing instruction is read in reverse order.

8. An integrated circuit containing a routing network, said routing network comprising a plurality of routers, each of said plurality of routers having input/output ports, in which each of the input/output ports of said router is associated with identifiers enabling each of the other input/output ports to locate it according to a code specific to each of them, each of said plurality of routers comprising:
means for identifying in an incident packet a routing instruction indicating a forward identifier of the desired output port;
means for sending back the packet where said forward identifier is suppressed from the routing instruction and a return identifier is inserted therein
wherein a packet sent from a source to a destination comprises a routing instruction containing the successive identifiers of the output port with respect to the input port for each of the routers through which the packet must transit.

9. A routing method in a routing network wherein each router comprises means for identifying, in a routing instruction of an incident packet, a forward identifier indicating the relative position of a desired output port, and means for sending back the packet by suppressing from the routing instruction said forward identifier and by inserting a return identifier therein, said method comprising, to send a message from a source to a destination, the step of sending from the source the sequence of identifiers of the output ports to be selected by routers provided in advance to convey a data packet from the source to the destination.
